(19) United States
(12) Patent Application Publication
(10) Pub. No.: US 2022/0414523 A1
(43) Pub. Date: Dec. 29, 2022

(54) Information Matching Using Automatically Generated Matching Algorithms

(71) Applicant: International Business Machines Corporation, Armonk, NY (US)

(72) Inventors: Mohammad Khatibi, Richmond Hill (CA); Eitan Daniel Farchi, Pardes Hana (IL); Martin Oberhofer, Sindelfingen (DE)

(21) Appl. No.: 17/305,001

(22) Filed: Jun. 29, 2021

(51) Int. Cl. G06N 20/00; G06F 16/33

(52) U.S. Cl. CPC G06N 20/00; G06F 16/3331

(57) ABSTRACT

A method processes information. Training pairs are generated by a computer system using matching fields in matching pairs of records for a data type, wherein matches are present between the matching fields in the matching pairs of records. Similarities between the training pairs are determined by the computer system using an importance map with importance values for the matching fields. Shapley values are determined by the computer system using the training pairs and the similarities between the training pairs. The importance map is adjusted by the computer system using the Shapley values.

### BACKGROUND

### 1. Field

The disclosure relates generally to an improved computer system and more specifically to a method, apparatus, computer system, and computer program product for matching information.

### 2. Description of the Related Art

Master data management systems can be used to ensure uniformity, accuracy, and consistency of information. Information can be, for example, information about a person or business entity. These types of master data systems can provide matching functionality when more than one copy of information is present. Ensuring alignment of data values across copies of information can be a difficult process. Inevitably, different versions of information can occur about a particular person or entity.

A master data management system can operate to eliminate duplicate copies of information. Matching processes can be run to detect and prevent or eliminate duplicate information. This function can be run in batch and real time. This function can be run on large data sets that have, for example, billions of records. Current matching algorithms do not have the ability match all data types in the information or match the information with a desired accuracy for data types may be handled. For example, an algorithm that matches information for people is unable to match information for other data types that may be present in the information that is processed. For example, the information can include data types such as a car, produce, or a dog.

Therefore, it would be desirable to have a method and apparatus that take into account at least some of the issues discussed above, as well as other possible issues. For example, it would be desirable to have a method and apparatus that overcome a technical problem with matching large amounts of information.

### SUMMARY

According to one illustrative embodiment, a method processes information. Training pairs are generated by a computer system using matching fields in matching pairs of records for a data type, wherein matches are present between the matching fields in the matching pairs of records. Similarities between the training pairs are determined by the computer system using an importance map with importance values for the matching fields. Shapley values are determined by the computer system using the training pairs and the similarities between the training pairs. The importance map is adjusted by the computer system using the Shapley values.

According to another illustrative embodiment, a matching system comprises a computer system that executes instructions to generate training pairs using matching fields in the matching pairs of records for a data type, wherein matches are present between the matching fields in the matching pairs of records; determine similarities between the training pairs using an importance map with importance values for the matching fields; determine Shapley values using the training pairs and the similarities between the training pairs; and adjust the importance map using the Shapley values.

According to yet another illustrative embodiment, a computer program product for processing information, the computer program product comprising a computer readable storage medium having program instructions embodied therewith, the program instructions executable by a computer system to cause the computer system to perform a method of generating, by the computer system, training pairs using matching fields in matching pairs of records for a data type, wherein matches are present between the matching fields in the matching pairs of records; determining, by the computer system, similarities between the training pairs using an importance map with importance values for the matching fields; determining, by the computer system, Shapley values using the training pairs and the similarities between the training pairs; and adjusting, by the computer system, the importance map using the Shapley values.

### BRIEF DESCRIPTION OF THE DRAWINGS

FIG. 1 is a pictorial representation of a network of data processing systems in which illustrative embodiments may be implemented;

FIG. 2 is a block diagram of an information environment in accordance with an illustrative embodiment;

FIG. 3 is a block diagram illustrating a selection of training pairs in accordance with an illustrative embodiment;

FIG. 4 is a diagram of an importance map in accordance with an illustrative embodiment;

FIG. 5 is an illustration of a matching pair of records and a training pair generated from the matching pair in accordance with an illustrative embodiment;

FIG. 6 is a flowchart of a process for processing information in accordance with an illustrative embodiment;

FIG. 7 is a flowchart of a process for selecting regions in accordance with an illustrative embodiment;

FIG. 8 is a flowchart of a process generating training pairs in accordance with an illustrative embodiment;

FIG. 9 is a flowchart of a process for identifying matching pairs of records in accordance with an illustrative embodiment;

FIG. 10 is a flowchart of a process for determining Shapley values in accordance with an illustrative embodiment;

FIG. 11 is a flowchart of a process for adjusting an importance map using Shapley values in accordance with an illustrative embodiment;

FIGS. 12A and 12B are a more detailed flowchart of a process for generating an importance map for a matching process in accordance with an illustrative embodiment;

FIG. 13 is a flowchart of a process for generating training pairs in accordance with an illustrative embodiment;

FIG. 14 is a flowchart of a process for refining training pairs in accordance with an illustrative embodiment;

FIG. 15 is a graph of Shapley values and importance values in accordance with an illustrative embodiment; and

FIG. 16 is a block diagram of a data processing system in accordance with an illustrative embodiment.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The illustrative embodiments recognize and take account one or more different considerations. For example, the illustrative embodiments recognize and take into account that current matching algorithms are unable to match data of different data types with a desired level of accuracy. The illustrative embodiments recognize and take into account that matching algorithms are generated for a specific data type such as persons or organizations. As a result, when a different data type is encountered than the specific data for which the matching algorithm was generated, the matching algorithm is unable to accurately match the information.

The illustrative embodiments recognize and take into account that current matching algorithms focus on a subset of attributes such as name, address, date of birth, identifier, or other attributes. The illustrative embodiments recognize and take account that some of this information may not be present, may not be complete, or may not have sufficient governance to be trustworthy for use by the matching algorithm to match information. The illustrative embodiments recognize and take into account that that the reliability and make up of information can change over time resulting in a matching algorithm that previously matched information with a desired level of accuracy may no longer provide that desired level of accuracy.

The illustrative embodiments recognize and take into account that it would be desirable to be able to determine what attributes are reliable and what attributes are not reliable using existing information or training information. The illustrative embodiments recognize and take into account that it would be desirable to be able to dynamically change the matching algorithm or generate new matching algorithms to take into account changes in the makeup of information.

The illustrative embodiments recognize and take into account that comprehending, ordering, and iteratively tuning parameters in matching algorithms can be more difficult than desired. The illustrative embodiments recognize and take into account that these parameters include distance coefficient vectors, wave vectors, and score thresholds. The illustrative embodiments also recognize and take into account that an inability is present in current matching algorithms to define additional matching outcomes with current outcomes such as “matched”, “to be reviewed”, and “unmatched”.

The illustrative embodiments recognize and take into account that it would be desirable to obtain insight directly from the information organized to identify what information may be reliable and what the information may be unreliable for a particular data type for purposes of matching information of that data type. The illustrative embodiments recognize and take into account that with this information, a matching process can be automatically generated for a particular data type when the reliability or usefulness of the attributes in different fields is known. The illustrative embodiments recognize and take account that the identification of the importance of attributes in different fields in a selected data type can be used in a process to train a machine learning model to match information for the selected data type with increased accuracy as compared to current techniques for generating matching algorithms.

Thus, illustrative embodiments of the present invention provide a computer implemented method, computer system, and computer program product for processing information. In one illustrative example, a method processes information. Training pairs can be generated by a computer system using matching fields in matching pairs of records for a data type, wherein matches are present between the matching fields in the matching pairs of records. Similarities between the training pairs can be determined by the computer system using an importance map with importance values for the matching fields. Shapley values can be determined by the computer system using the training pairs and the similarities between the training pairs. The importance map can be adjusted by the computer system using the Shapley values.

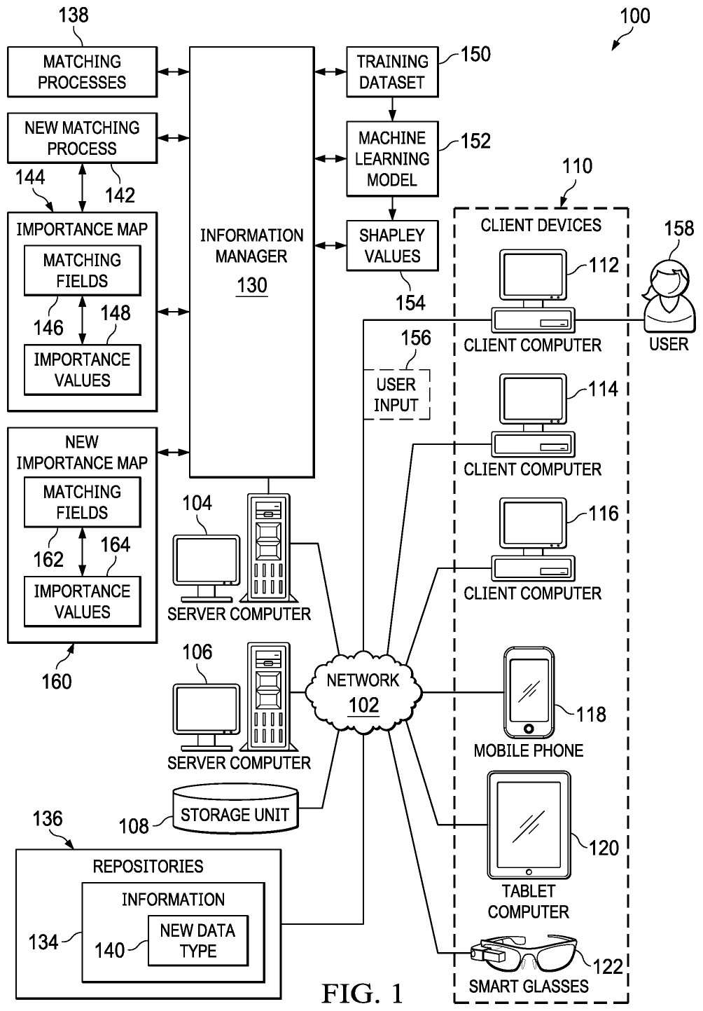

With reference now to the figures and, in particular, with reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client devices 110 connect to network 102. As depicted, client devices 110 include client computer 112, client computer 114, and client computer 116. Client devices 110 can be, for example, computers, workstations, or network computers. In the depicted example, server computer 104 provides information, such as boot files, operating system images, and applications to client devices 110. Further, client devices 110 can also include other types of client devices such as mobile phone 118, tablet computer 120, and smart glasses 122. In this illustrative example, server computer 104, server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program instructions located in network data processing system 100 can be stored on a computer-recordable storage media and downloaded to a data processing system or other device for use. For example, program instructions can be stored on a computer-recordable storage media on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

As used herein, “a number of” when used with reference to items, means one or more items. For example, “a number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

In this illustrative example, information manager 130 can match information 134 in repositories 136, which can take a number of different forms. For example, repositories 136 can be selected from at least one of a database, a data warehouse, a data mart, a cloud repository, or other type of storage.

In this illustrative example, information manager 130 can perform matching functions for information of different data types in information 134 stored in repositories 136. Information manager 130 can provide these matching functions using matching processes 138. Matching processes 138 can be algorithms or other processes. In this illustrative example, a matching process in matching processes 138 is capable of matching information 134 for a particular data type. Information 134 of other datatypes may not be matched properly or with the desired level of accuracy.

When information manager 130 encounters new data type 140 in information 134 that is not supported by the matching processes 138, information manager 130 can generate new matching process 142 that is capable of matching information 134 having new data type 140 that the current matching processes in matching processes 138 are unable to handle with a desired level of accuracy. In this illustrative example, information manager 130 can generate an importance map 144 for new matching process 142. Importance map 144 contains matching fields 146 with importance values 148 that indicate the importance of particular fields in matching fields 146 for matching information 134. The selection of matching fields 146 and importance values 148 in importance map 144 can be made in a manner that enables matching information for new data type 140 with a desired level of accuracy.

In this illustrative example, information manager 130 determines Shapley values 154. These values can be used to generate importance map 144 with matching fields 146 and importance values 128 in a manner that provides a desired level of accuracy for matching for information 134 having new data type 140. As depicted, information manager 130 can generate training data set 150 and use this training data set to train machine learning model 152 to determine Shapley values 154. The training data set is an initial training data set and can be generated using a default or importance map for another data type for generating importance map 144.

Importance map 144 can be used to generate another training data set to train machine learning model 152 to output new values for Shapley values 154. These new values for Shapley values 154 can be used to adjust to importance map 144. This adjustment can result in increased accuracy in matching information 134 having new data type 140.

These adjustments to importance map 144 can include at least one of changing a matching field in matching fields 146 or changing importance value in importance values 148. For example, Shapley values 154 can be used to generate new importance map 160 having matching fields 162 with importance values. New importance map 160 can be compared to importance map 144 to determine whether importance map 144 is sufficiently accurate. For example, if the difference between importance values 164 in new importance map 160 and importance values in importance map 144 are sufficiently close, importance map 144 can be used with new matching process 142 to match information for new data type 140. Whether importance values 164 in new importance map 160 and importance values in importance map 144 are sufficiently close can be determined by thresholds, desired error, or user input in this illustrative example.

If the difference between importance values 164 in new importance map 160 and importance values in importance map 144 are not sufficiently close, the process can be repeated using importance map 144 with adjustments to create another training data set that can be used to train machine learning model 152 to generate new values for Shapley values 154. This process can be performed repeatedly until differences between importance map 144 and importance values based on Shapley values 154 are sufficiently close to each other. In one illustrative example, sufficiently close can be when the items are the same or within a tolerance or threshold level.

This process of generating importance map 144 for use by new matching process 142 can be performed with user input 156 received from user 158 operating client computer 112. For example, user 158 can make changes to matching fields 146. As another example, user input 156 from user 158 can be received to adjust importance values 148.

Further, user 158 can also provide user input identifying matching outcomes. For example, user 158 can select the number of target regions and their expected boundaries for different matching outcomes. For example, a matching outcome of confidently matched can be selected in which confidently match is present when the probability of a match is greater than 75%. A matching outcome of confidently unmatched can be determined when the probability of a match is less than 75%. As another example, target regions such as confidently unmatched, likely unmatched, to be reviewed, likely matched, and confidently matched, can be selected by user 158.

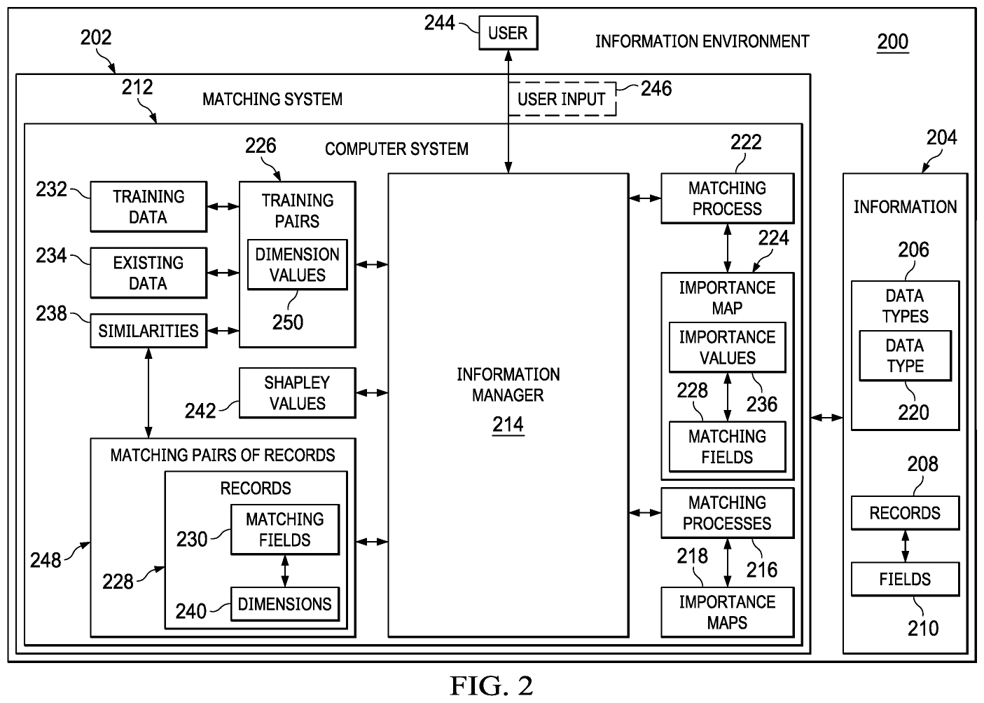

With reference now to FIG. 2, a block diagram of an information environment is depicted in accordance with an illustrative embodiment. In this illustrative example, information environment 200 includes components that can be implemented in hardware such as the hardware shown in network data processing system 100 in FIG. 1.

In this illustrative example, matching system 202 in information environment 200 provides a matching function for information 204 to match information 204 with data types 206. In this illustrative example, data types 206 can take a number of different forms. For example, data types 206 can be selected from at least one of a person, an organization, a vehicle, an aircraft, a truck, a building, a city, a government agency, or some other suitable type of data type. In this illustrative example, information 204 can be stored in data structures such as records 208 having fields 210. In other words, each record in records 208 can have one or more of fields 210.

In this example, matching system 202 comprises a number of different components. As depicted, matching system 202 comprises computer system 212 and information manager 214.

Information manager 214 can be implemented in software, hardware, firmware, or a combination thereof. When software is used, the operations performed by information manager 214 can be implemented in program instructions configured to run on hardware, such as a processor unit. When firmware is used, the operations performed by information manager 214 can be implemented in program instructions and data and stored in persistent memory to run on a processor unit. When hardware is employed, the hardware may include circuits that operate to perform the operations in information manager 214.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, information manager 214 in matching system 202 can perform matching using matching processes 216 to determine matches are present between records 208 containing information 204. Matching processes 216 can perform the matching by comparing information 204 in records 208 to identify matches between records 208.

In this illustrative example, matching processes 216 can perform matching using importance maps 218. These importance maps can be configured to provide a desired level of accuracy for matching records 208 for different data types in data types 206.

For example, an importance map for a matching process in matching processes 216 can enable matching information in records 208 for a first data type in data types 206 with a desired level of accuracy. For a second data type in data types 206, a different importance map in importance maps 218 can be used with another matching process in matching processes 216 to obtain a desired level accuracy in matching information 204 of the second data type in data types 206.

When data type 220 in data types 206 is present in information 204 and is not supported by matching processes 216 using importance maps 218, information manager 214 can generate matching process 222 to perform matching for data type 220. In this illustrative example, information manager 214 can generate importance map 224 for data type 220. In other words, with importance map 224, matching process 222 can match records 208 for information 204 of data type 220 with a higher-level accuracy as compared to matching processes 216 using importance maps 218. In generating matching process 222, information manager 214 can create entirely a new matching process or modifying an existing matching process in matching processes 216.

As depicted, information manager 214 can generate training pairs 226 using matching fields 230 in matching pairs of records 248. In this illustrative example, matching pairs of records 248 comprises pairs of records 208 for data type 220. In this illustrative example, matching fields 230 are fields selected for use in matching records. Matching fields 230 can be a subset of fields 210. In other words, the matching process does not require performing matching of all fields in records 208.

In this illustrative example, information manager 214 determines similarities 238 between matching pairs of records 248 using importance map 224 with importance values 236 for the matching fields 230. Importance values 236 can indicate how important each of matching fields 230 are in records 208 for matching records 208. More specifically, importance values 236 can indicate how important dimensions 240 are for matching fields 228.

As depicted, similarities 238 can be between matching pairs of records 248. In other words, a similarity in similarities 238 can be determined for two records in a matching pair of records in matching pairs of records 248. The similarity for the matching pair of records can be an overall similarity based the over similarity of matching fields 230 for those two records in the matching pair of records in matching pairs of records 248. In other words, the similarity for each matching field can be determined and those similarities can be combined to form the similarity for that matching pair of records.

In this illustrative example, training pairs 226 can be generated by information manager 214 using matching pairs of records 248. In this illustrative example, information manager 214 can determine dimensions 240 for matching fields 230 in records 208.

As depicted, dimensions 240 identifies the type of metric or parameter for the comparison. Dimensions 240 can be selected from at least one of an exact match, a partial match, an equivalent, unmatched, a partial match, an initial, a phonetic, missing, left out, a distance, or some other type of measurement that can be made by comparing information in corresponding fields in a matching pair of records.

For example, “exact match” is John vs John; “equivalent” is Bob vs Robert; “phonetic” is John vs Jon; initial is John vs J. As another example, “partial” is John vs Johnson; unmatched is John vs Alex. The dimension “left out” is John Brand vs John Brad Allen and “missing” is John vs n/a. Each matching field can have a number of dimensions. Different matching fields can have different dimensions and these illustrative examples.

Information manager 214 can use these dimensions to generate training pairs 226. In this illustrative example, training pairs 226 comprises dimension values 250, which are values determined for dimensions 240. In this illustrative example, dimension values 250 can be determined by comparing matching fields 230 between the two records in a matching pair of records in matching pairs of records 248.

Information manager 214 can determine Shapley values 242 using training pairs 226 and similarities 238 between training pairs 226. Information manager 214 can adjust importance map 224 using Shapley values 242.

In this illustrative example, the adjustment of importance map 224 can take a number of different forms. For example, a number of adjustments to importance map 224 can include adjusting at least one of a value in importance values 236, a matching field in matching fields 230, a dimension in dimensions 240 for the matching field in matching fields 230, or some other suitable adjustment.

For example, information manager 214 can adjust matching fields 230 in importance map 224. This adjustment can change what fields in fields 210 are used to determine whether records 208 matched each other when using matching process 222 to match information 204. The importance values 236 for at least one of matching fields 230 or dimensions 240 can be adjusted to take into account which ones of matching fields 230 are important to consider in determining whether a match is present between records 208.

For example, information manager 214 can adjust one or more of dimensions 240 using importance map 224. In this example, if an importance value in importance values 236 for a selected dimension in dimensions 240 has about the same importance value for all possible values of that selected dimension, the selected dimension is a candidate for removal. This removal of the selected dimension can simplify the process of determining similarities 238.

In this illustrative example, the steps of generating training pairs 226, determining similarities 238, determining Shapley values 242, and adjusting importance map 224 can be repeated until similarities 238 determined for training pairs 226 using importance map 224 are satisfactory for data type 220. When performing these steps again after adjusting importance map 224, the new Shapley values can be different from Shapley values 242. The new Shapley values can be used to make further adjustments to importance map 224.

Determining when similarities 238 are satisfactory for data type 220 can be performed a number of different ways. For example, similarities 238 can be satisfactory when importance values 236 between the current importance map made after adjustments and the prior importance map before adjustments are sufficiently close to each other. For example, information manager 214 can compare importance map 224 adjusted with Shapley values 242 to importance map 224 without adjustments to form a comparison. A threshold or value can be used to determine when the similarities sufficiently close.

Further as another illustrative example, similarities 238 can be satisfactory when, for example, rate of pairs with incorrect association to each region do not exceed the selected maximum error rates for each of all regions. User 244 may tolerate some maximum error rate in each region. With the illustrative example, user 244 can send user input 246 that specifies a maximum error rate for each region.

With this example, similarities 238 can be satisfactory when the rate of pairs with incorrect matches to each region do not exceed the applicable maximum error rates for each of the regions. In other illustrative examples, a default maximum error can be used. For example, a region for matches may have a lower error rate selected as compared to a region for no match. In this example, the selection of different error rates for match and no match can depend on importance of if an error occurs in matching records versus not matching records.

In illustrative example, user 244 may provide user input 246 in the process in generating matching process 222. For example, user input 246 can be used to adjust various components in importance map 224. Further, user input 246 can also be used to determine whether to perform another iteration or determination of Shapley values 242 to further adjust importance map 224. User input 246 can enable user 244 to make decisions on suggestions provided by information manager 214. For example, information manager 214 can provide suggestions as to adding, removing, or changing a matching field in matching fields 230. User 244 can have knowledge or experience that enables at least one of reducing the number of iterations in generating training pairs 226, determining similarities 238, determining Shapley values 242, or adjusting importance map 224. Further, user 244 may also determine when importance map 224 is sufficient based on similarities 238.

In illustrative example, user input 246 is optional. In some illustrative examples, generating matching process 222 with importance map 224 can be performed automatically without needing user input. The different decisions can be performed based on settings for thresholds, tolerances, preselected changes, or other operations that can be selected ahead of time such that the user input 246 is not needed during the generation of matching process 222 with importance map 224.

When importance map 224 is considered to be sufficient for use in managing information 204 for data type 220, importance map 224 can be implemented in or associated with, or otherwise provided to matching process 216 for using in matching information 204. Information manager 214 can perform matching of information 204 of data type 220 with matching process 216 using importance map 224 adjusted using Shapley values 242.

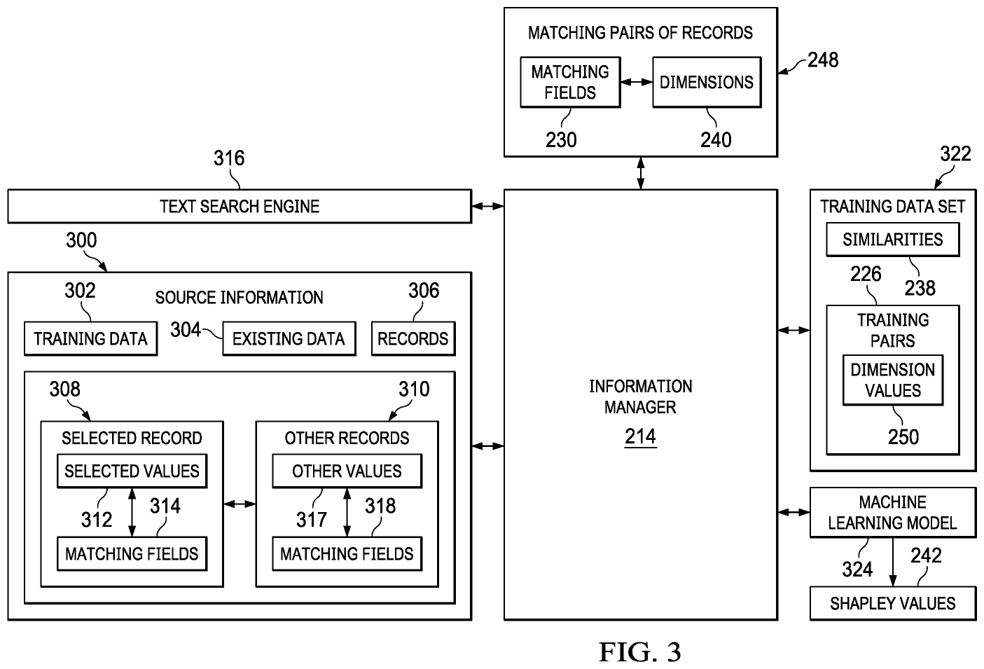

With reference now to FIG. 3, a block diagram illustrating a selection of training pairs is depicted in accordance with an illustrative embodiment. In this illustrative example, information manager 214 can generate training pairs 226 from source information 300. In this illustrative example, source information 300 can have data type 220. In the illustrative examples, the same reference numeral may be used in more than one figure. This reuse of a reference numeral in different figures represents the same element in the different figures.

Source information 300 can take a number of different forms. For example, source information 300 can include at least one of training data 302, existing data 304, or other sources of information. Training data 302 can comprise records having fields discovered through processing of the records. Existing data 234 can be records that have been previously processed and matched. In this illustrative example, source information 300 can be organized in data structures such as records 306.

As depicted, information manager 214 can standardize source information 300 used to generate training pairs 226 from records 306 prior to generating training pairs 226. For example, the standardization for various aspects of source information 300. The standardization can be, for example, selecting a common format, a number type, selecting word for words having equivalences in source information 300, or other types of standardization.

In this illustrative example, information manager 214 can identify matching pairs of records 248, which comprises pairs of records 328 identified from records 306 in source information 300. Matching pairs of records 248 can be used to generate training pairs 226. For example, information manager 214 can identify matching pairs of records 248 as matches between selected record 308 and other records 310. In this illustrative example, selected record 308 can be randomly selected, sequentially selected, or selected based on criteria such as order, date created, or some other parameter. Selected record 308 can be compared with other records 310 to identify matching pairs of records 248.

For example, information manager 214 can match selected values 312 for matching fields 314 in selected record 308 with other values 317 for matching fields 318 in other records 310 to identify matching pairs of records 248. In this illustrative example, matching fields 314 in selected record 308 and matching fields 318 in other records 310 can be identified using matching fields 230 specified in importance map 224. This searching using text search engine 316 identifies matching pairs of records 248. As depicted, matching pairs of records 248 are for pairs of records 326 that have been matched by text searching engine 316. For example, a matching pair in matching pairs of records 248 can be selected record 308 and another record in other records 310 that have been matched to each other. After matching pairs of records 248 have been identified using selected record 308, another record can be selected for matching records 306. This process can be performed until all of records 306 have been processed or a desired number of matching pairs of records 248 have been identified.

The matching can be performed using text search engine 316. In this illustrative example, text search engine 316 can perform full text search and can be implemented using currently available text search engines that provide full text search capabilities. Text search engine 316 can examine all of the words in each record in other records 310 to determine whether match criteria are met. In this illustrative example, the match criteria are selected values 312. This full text searching does not distinguish between values found in different fields. For example, “John” in a first name field matches “John” in a street address field.

In this illustrative example, information manager 214 can use matching pairs of records 248 to generate training pairs 226. In this illustrative example, information manager 214 generates training pairs 226 from a comparison of matching pairs of records 248. In illustrative example, dimensions 320 are present for matching fields 230. In other words, each matching field in matching fields 230 in training pairs 226 can have a number of dimensions 320. Dimensions 320 for a particular matching field can be different from another matching field but are the same between corresponding matching fields in matching fields 230 in training pairs 226.

In generating training pairs 226, information manager 214 can determine dimension values 254 for dimensions 240 for each of matching fields 230 in a matching pair in matching pairs of records 248. For example, dimension values 250 can be determined for dimensions 240 for matching fields 314 in selected record 308 and matching fields 318 in another record in other records 310. For example, a dimension value can be a number of tokens for exact match between fields in a matching pair, a distance between the fields in a matching pair, or some other type of value. As result, training pairs 226 can comprise dimension values 254 dimensions 240 determine for matching fields 230 for matching pairs of records 248 for matching pairs of records 248.

In this illustrative example, information manager 214 can determine similarities 238 between matching pairs of records 248 using dimension values 250 for dimensions 240. In this example, dimension values 250 for dimensions 240 can be used to determine similarities 238 between matching pairs of records 248. Similarities 238 determined between matching pairs of records 248 are associated with training pairs 226 corresponding to matching pairs of records 248. In other words, a similarity determined for a matching pair of records is associated with the training pair generated using that matching pair of records. Each training pair in training pairs 226 corresponds to a matching pair in matching pairs of records 248.

In this example, a similarity in similarities 238 for each matching pair of records in matching pairs of records 248 is the overall similarity of the matching fields for each matching pair in matching pairs of records 248. This overall similarity can be determined using dimensions 320 and importance values 236 from importance map 224. As a result, similarities 238 for training pairs 226 can comprise a similarity determined for each training pair in which the similarity for a training pair can be determined from dimension values 254 for dimensions 240 for a corresponding matching pair of records in matching pairs of records 248.

The importance value for a particular dimension in importance map 224 is a indicates the importance of that dimension in dimensions 240 for determining the similarity of a matching field between the two records in a matching pair of records. For example, if the importance values for dimensions in a first field such as last name is greater than the importance values dimensions for the second field such as first name, an equal number of words matching in both these fields in a matching pair of records results in the second field having a higher importance or value in determining whether a match is present between the two records. In other words, importance values can be used to increase the importance of matches for words in a last name field as compared to the same number matches for words in a first name field when comparing two records in a matching pair of records to determine the similarity of two records to each other in the matching.

In the illustrative example, each training pair in training pairs 226 can have dimension values 250 for dimensions 240 for matching fields 230 in a corresponding matching pair of records in matching pairs of records 248. Additionally, each training pair has a similarity for that training pair in similarities 238 in which the similarity is an overall similarity for all of dimensions 240 for all of matching fields 230.

Information manager 214 can associate similarities 238 with corresponding training pairs in training pairs 226 to form training data set 322. As depicted, training data set 322 can be used in training machine learning model 324 to generate the Shapley values 242.

Machine learning model 324 is a type of artificial intelligence model that can learn without being explicitly programmed. A machine learning model can learn based training data input into the machine learning model. The machine learning model can learn using various types of machine learning algorithms. The machine learning algorithms include at least one of a supervised learning, and unsupervised learning, a feature learning, a sparse dictionary learning, and anomaly detection, association rules, or other types of learning algorithms. In this illustrative example, the training techniques employing regression can include train machine learning techniques such as light gradient boosting model (LGBM), extreme gradient boosting (XGB), Random Forrest Regression, or other suitable machine learning techniques.

Examples of machine learning models include an artificial neural network, a decision tree, a support vector machine, a Bayesian network, a genetic algorithm, and other types of models. These machine learning models can be trained using data and process additional data to provide a desired output.

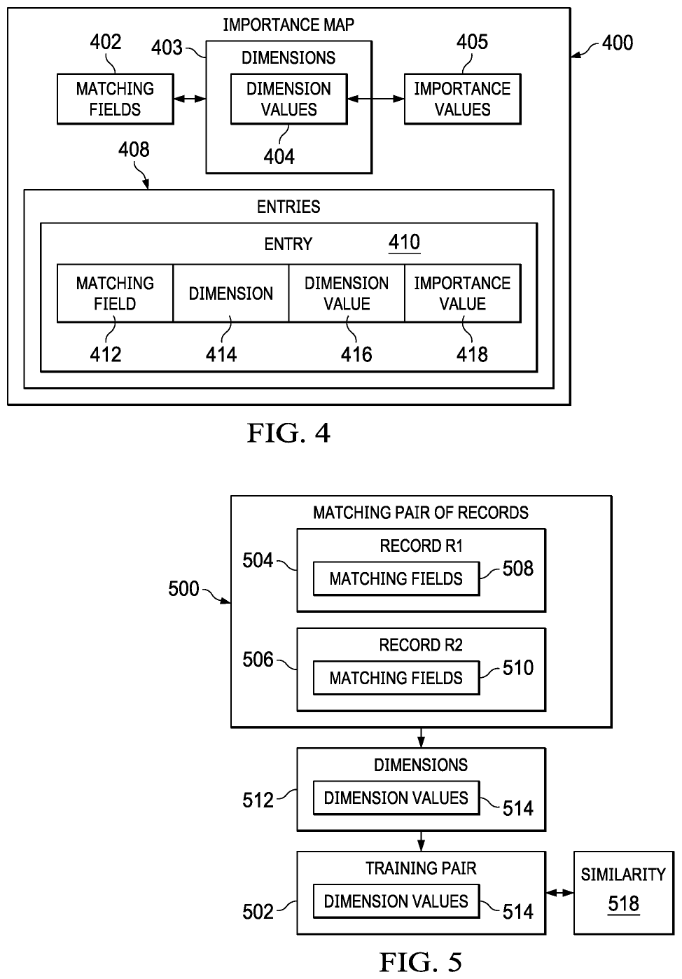

Turning now to FIG. 4, a diagram of an importance map is depicted in accordance with an illustrative embodiment. In this illustrative example, importance map 400 is an example of one implementation for importance map 224 in FIG. 2. As depicted, importance map 400 comprises matching fields 402, dimensions 403 with dimension values 404, and importance values 405.

In this illustrative example, matching fields 402 have dimensions 403 with dimension values 404. In other words, each matching field in matching fields 402 can have one or more of dimensions 403. Each dimension in dimensions 403 has a dimension value in dimension values 404. Dimension values 404 are determined based on a comparison of two records to each other. These two records can be, for example, matching records that are actual records compared during a matching of records using matching process 222.

In this illustrative example, each dimension value in dimension values 404 maps to or has an importance value in importance values 405. An importance value is an indication of the similarity between the corresponding matching fields in two records that are being compared.

As a result, each matching field in matching fields 402 can have multiple importance values 405 that contribute to the similarity of a matching field between the two records. Further, all of importance values 405 for matching fields 402 in a pair of records contribute to the similarity of that record to another record. The similarity between the two records identified through importance values 405 corresponding to dimension values 404 for dimensions 403 in matching fields 402 in the two records can also be referred to as an overall similarity or the two records.

As depicted, this information can be embodied in a number of different ways. For example, importance map 400 can have entries 408 that contain dimension values 404 for dimensions 403 in matching fields 402 map to importance values 405. In this depicted example, entry 410 comprises matching field 406, dimension 414, dimension value 416, and importance value 418.

In this illustrative example, matching field 412 identifies a matching field in matching fields 402 that is to be used for comparison in determining matches between two records. Dimension 414 identifies a dimension in matching field 412 that can be determined when comparing matching field 412 in the two records to each other. In this illustrative example, the determination of dimension 414 is dimension value 416.

As depicted, dimension 414 can be, for example, exact match (EX). Dimension value 416 can be the number of tokens that match in matching field 406 between the two records. The number of words that match are tokens. For example, when matching field 412 is name, Record 1 may have “John Allen Smith” and Record 2 may have “John Allen” as the name. Comparing the name field in these two records results in dimension value 416 being 2 tokens.

Importance value 418 indicates the value of dimension 414 based on dimension value 416. In this illustrative example, importance value 418 is a similarity value in similarity values that contributes to the overall similarity between two records corresponding to a training pair in training pairs 226. Importance value 418 may be, for example, 0.7 when dimension value 416 is 2 tokens. When dimension value 416 is 1 token, importance value 418 can be 0.4. In this illustrative example, importance value 418 indicates the similarity between matching field 412 in the two records for dimension 414.

In other words, importance value 418 is a value for similarity for comparing matching field 412 in the two records based on dimension value 416 for dimension 414. Importance value 418 for dimension 414 is one importance value that contributes to the similarity of matching field 412 and to the similarity between the two records.

For example, if a matching field has five dimensions, the dimension values for those five dimensions can be used to identify five importance values that indicate the similarity of that matching field between two records. Each importance value is a similarity value that contributes to the overall similarity between two records. As result, a matching field can be given a higher level of importance in matching records as compared to other matching fields based on the selection of importance values for dimensions for that matching field. The level of importance can be set based on the value for an importance value in a dimension from one matching field relative to other importance values for a dimension in another matching field.

Thus, when all of the importance values are identified for all of the dimensions in all of the matching fields between two records, the importance values, which are values indicating the similarity, can be summed or combined to identify a similarity between the two records. This similarity between two records can also be referred to as an overall similarity.

Further, if a dimension value for a dimension does not have exact correspondence to dimension values 404 in importance map 400, interpolation of importance values 405 can be performed to determine importance value for that particular dimension value.

In this illustrative example, additional entries can be present for each dimension in matching field 412. In another example, entry 410 can include additional fields or additional dimensions for matching field 412. Additionally, in another implementation and importance map can comprise one or more functions. For example, a function can be used for a dimension such that a dimension value can be input to obtain an importance value.

With reference next to FIG. 5, an illustration of a matching pair of records and a training pair generated from the matching pair is depicted in accordance with an illustrative embodiment. In this illustrative example, matching pair of records 500 is used to generate training pair 502.

As depicted, matching pair of records 500 is an example of a pair of records in matching pairs of records 248 in FIG. 2 and FIG. 3. In this illustrative example, matching pair of records 500 comprises record R1 504 and record R2 506. Record R1 504 has matching fields 508, and record R2 506 has matching fields 510. Matching fields 508 in record R1 504 and matching fields 510 in record R2 506 are the same fields in these two records. For example, if name, address, and occupation are matching fields 508 in record R1 504, name, address, and occupation are matching fields 510 in record R2 506.

In this illustrative example, dimension values 514 are generated for dimensions 512 from a comparison of matching fields 508 between record R1 504 and record R2 506. Each matching field in matching fields 508 and matching fields 510 can have one or more dimensions. Those dimensions may be different between different matching fields.

For example, field 1 in the matching fields for the two records can be dimensions dim1, dim2, dim3, and dim4. Field 2 in the matching fields for the two records can have dimensions such as dim5, dim6, and dim7 while field 3 in the matching fields can have dimensions such as dim1, dim2, dim5, and dim6.

Dimensions 512 has dimension values 514. In other words, each of these dimensions in dimensions 512 has a value in dimension values 514. In this illustrative example, dimension values 514 for dimensions 512 are placed in training pair 502. Dimension values 514 can be represented as a flat file in training pair 502.

In this illustrative example, similarity 516 can be computed from the similarities of dimensions 512 determined from matching fields 508 in record R1 504 and matching fields 510 in record R2 506. Similarity 518 for all of dimensions 512 for all of the matching fields, matching fields 508 and matching fields 510, can also be referred to as an overall similarity for training pair 502 in which the similarities determined for dimensions 512 contribute to similarity 518. In this illustrative example, similarity 518 can be computed using importance map 224 and dimension values 514 can be used to determine importance values that contribute to determine similarity 518.

In one illustrative example, one or more technical solutions are present that overcome a technical problem with matching information happened different data types. As a result, one or more technical solutions may provide a technical effect generating new matching processes when new data types are encountered. One or more technical solutions may provide a technical effect of enabling generating new matching processes using training pairs to determine Shapley values for generating importance map or the matching processes. One or more technical solutions enable iteratively updating importance map using Shapley values to reach a desired level of similarity.

Computer system 212 in FIG. 2 can be configured to perform at least one of the steps, operations, or actions described in the different illustrative examples using software, hardware, firmware, or a combination thereof. As a result, computer system 212 operates as a special purpose computer system in which information manager 214 in computer system 212 enables generating new matching processes as new data types are encountered. In manner, increase flexibility is present in matching information that may include unknown data types that are not supported by current matching processes . . . . In particular, information manager 214 transforms computer system 212 into a special purpose computer system as compared to currently available general computer systems that do not have information manager 214.

The illustration of information environment 200 in the different components in FIGS. 2-5 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, a similarity in similarities 238 in training data set 322 has been described as a similarity for a training pair that corresponds to a pair of records. The similarity is also referred to as overall similarity for the training pair in training pairs 226. In other illustrative examples, similarities 238 can be the similarities between dimensions 240 for matching fields 230. In other words, a finer level of granularity can be present in similarities 238 in some illustrative examples.

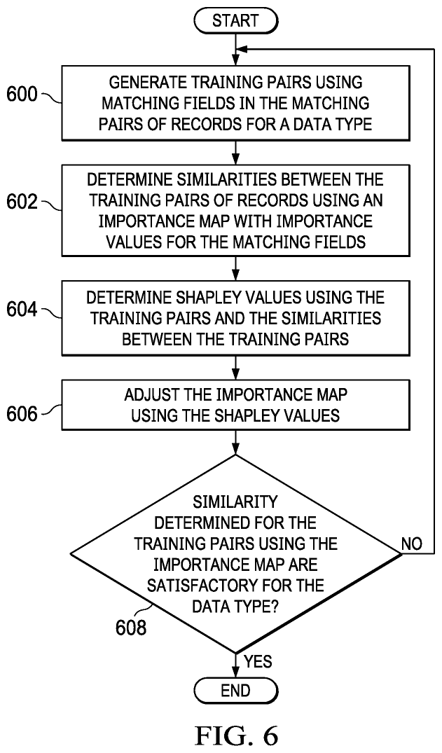

Turning next to FIG. 6, a flowchart of a process for processing information is depicted in accordance with an illustrative embodiment. The process in FIG. 6 can be implemented in hardware, software, or both. When implemented in software, the process can take the form of program instructions that is run by one of more processor units located in one or more hardware devices in one or more computer systems. For example, the process can be implemented in information manager 130 in FIG. 1 or information manager 214 in computer system 212 in FIG. 2.

The process begins by generating training pairs using matching fields in the matching pairs of records for a data type (step 600). In step 600, matches are present between the matching fields in the matching pairs of records. The process determines similarities between the training pairs using an importance map with importance values for the matching fields (step 602). In step 602, the importance values can be specifically for indicating the importance of dimensions determined for the matching fields. In other words, the importance values can be used to determine a similarity for each dimension in a matching field based on the dimension value for that dimension.

The process determines Shapley values using the training pairs and the similarities between the training pairs (step 604). The process adjusts the importance map using the Shapley values (step 606). In this illustrative example, the adjustment can include at least one of changing an importance value, adding a matching field, removing a matching field, at any dimension, removing a dimension, or some other suitable change. In one illustrative example, when changing importance values, the Shapley values can be used to generate a new importance map. The adjustment of the current importance map can be made by replacing that importance map with the new importance map.

A determination is made as to whether the similarities determined for the training pairs using the importance map are satisfactory for the data type (step 608). In step 608, the importance map adjusted using the Shapley values can be compared to the importance map without adjustments to form a comparison. This comparison can be used in determining whether the similarities are satisfactory. In step 608, a comparison of the importance map without adjustments and the importance map with adjustments with each other can be made to determine the difference in the importance values. When difference in importance values is absent or negligible then the similarities can be considered to be satisfactory for the data type. The difference can be based on some default value, a maximum error rate, or user input.

If the similarities are satisfactory, process terminates thereafter. Otherwise, the process returns to step 600 to generate additional training pairs. This process can be performed iteratively in which each iteration uses the importance map with adjustments from the Shapley values to determine new training pairs that can be used to determine new Shapley values. These new Shapley values can then be used to adjust the importance map.

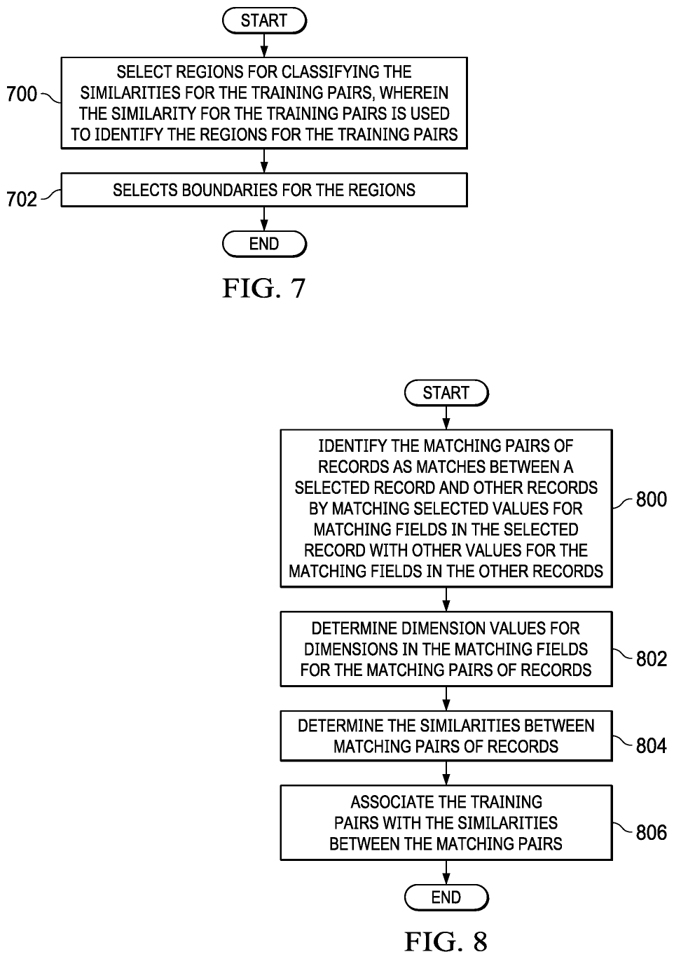

Turning now to FIG. 7, a flowchart of a process for selecting regions is depicted in accordance with an illustrative embodiment. The process illustrated in is an example of an additional steps that can be used in the process in FIG. 6.

The process selects regions for classifying the similarities for the training pairs, wherein the similarity for the training pairs is used to identify the regions for the training pairs (step 700). The process selects boundaries for the regions (step 702). Process terminates thereafter.

These regions can be used to determine matching outcomes based on the overall similarity determined for fields between two records such as those in training pairs or actual records being compared. These matching outcomes can also be referred to as results.

For example, the regions can include confidently unmatched and confidently match. Confidently unmatched can be a similarity of less than 75% while confidently matched can be a similarity of equal to or greater than 75%.

As another example, the regions can include confidently unmatched, review, confidently matched. In this example, confidently unmatched can be a similarity of less than 75%, review can be a similarity between 75% to 90%, and confidently matched can be a similarity of greater than 90%.

In yet another illustrative example, the regions can include confidently unmatched, likely unmatched, review, likely matched, confidently matched. In this example, confidently unmatched can be a similarity of less than 70%. Likely unmatched can be a similarity of 70% to 75%. Review can be a similarity of 75% to 85%. Likely matched can be a similarity of 85% to 90%, and confidently matched can be a similarity of greater than 90%.

With reference to FIG. 8, a flowchart of a process for generating training pairs is depicted in accordance with an illustrative embodiment. The process illustrated in is an example of an implementation for step 600 in FIG. 6.

The process begins by identifying the matching pairs of records as matches between a selected record and other records by matching selected values for matching fields in the selected record with other values for the matching fields in the other records (step 800). Step 800 can be performed for any number of selected records.

The process determines dimension values for dimensions in the matching fields for the matching pairs of records (step 802). The process determines the similarities between matching pairs of records (step 804).

The process associates the training pairs with the similarities between the matching pairs (step 806). The process terminates thereafter. In step 806, wherein the dimension values and the similarities are used for training a machine learning model to generate the Shapley values. In this illustrative example, the training pairs and the similarities for the training pairs form a training data set such as training data set 322 in FIG. 3.

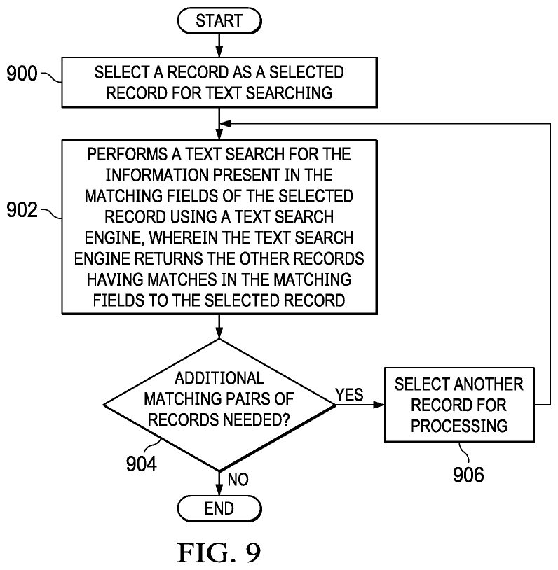

Turning next to FIG. 9, a flowchart of a process for identifying matching pairs of records is depicted in accordance with an illustrative embodiment. The process in FIG. 9 is an example one manner in which step 800 in FIG. 8 can be implemented.

The process begins by selecting a record as a selected record for text searching (step 900). In step 900 the selection of the selected record can be performed randomly.

The process performs a text search for the information present in the matching fields of the selected record using a text search engine, wherein the text search engine returns the other records having matches in the matching fields to the selected record (step 902). In step 902, values in a matching field in the selected record are compared with the values in all of the fields in another record that is compared to the selected record in determining whether a match is present. In this depicted example, the values can be text and in particular the values can be words. A match between values does not have to be within the same field for the text search engine to identify a match between the selected record and another record.

A determination is made as to whether additional matching pairs of record are needed (step 904). The number of matching pairs identified can be based on the amount of training data desired. If additional matching pairs of records are needed, the process selects another record for processing (step 906). The process then returns to step 902. If additional records are not needed in step 904, the process terminates.

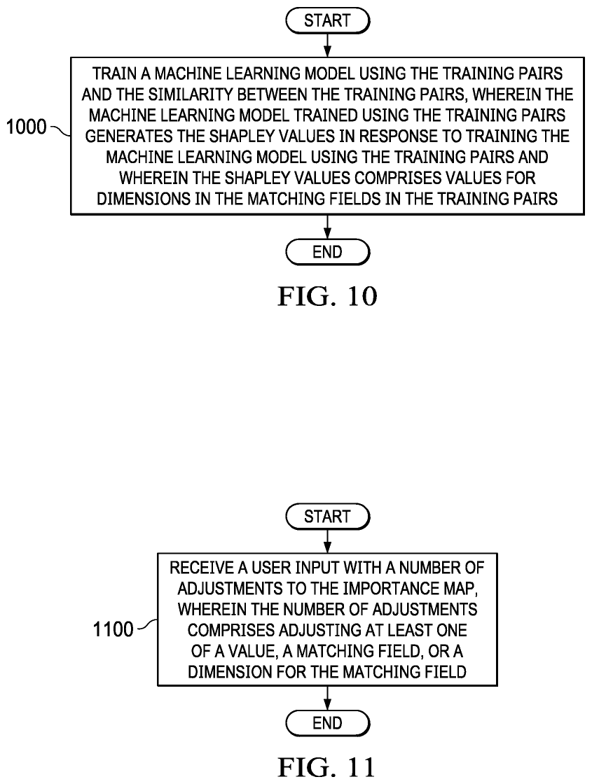

In FIG. 10, a flowchart of a process for determining Shapley values is depicted in accordance with an illustrative embodiment. The process in this figure is an example of one implementation for step 604 in FIG. 6.

The process trains a machine learning model using the training pairs and the similarities between the training pairs, wherein the machine learning model trained using the training pairs generates the Shapley values in response to training the machine learning model using the training pairs and wherein the Shapley values comprises values for dimensions in the matching fields in the training pairs (step 1000). The process terminates thereafter.

With reference now to FIG. 11, a flowchart of a process for adjusting an importance map using Shapley values is depicted in accordance with an illustrative embodiment. The process illustrated in this figure is an example of one implementation for step 606 in FIG. 6.

The process receives a user input with a number of adjustments to the importance map, wherein the number of adjustments comprises adjusting at least one of a value, a matching field, or a dimension for the matching field (step 1100). The process terminates thereafter.

In other illustrative examples, step 1100 can be performed without needing user input. The different adjustments can be based off preselected adjustments that occur based on the amount error or similarity.

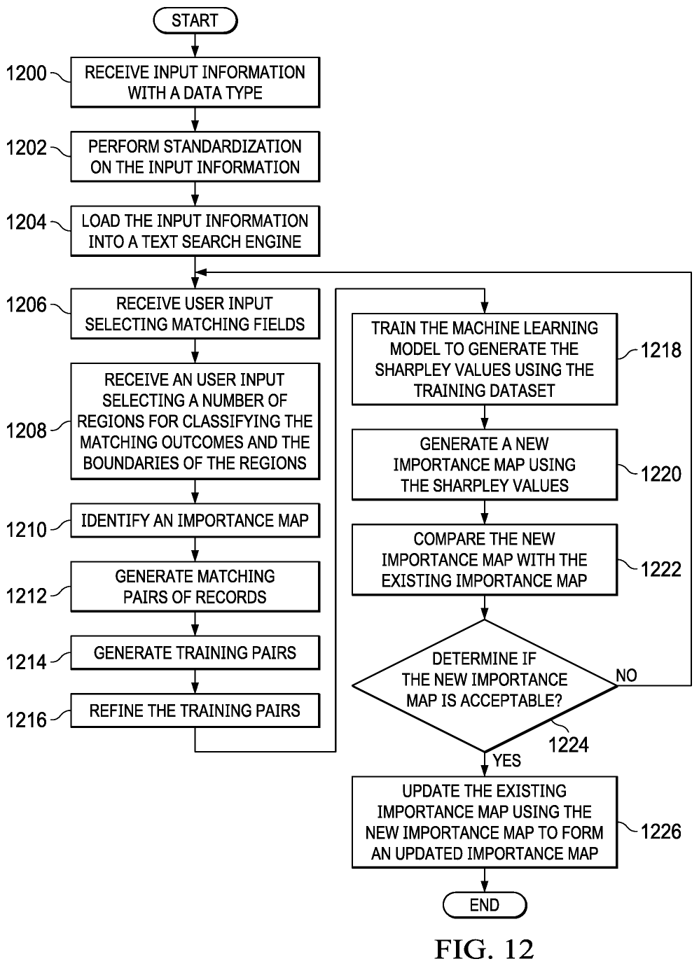

Turning next to FIGS. 12A and 12B, a more detailed flowchart of a process for generating an importance map for a matching process is depicted in accordance with an illustrative embodiment. The process in FIGS. 12A and 12B can be implemented in hardware, software, or both. When implemented in software, the process can take the form of program code that is run by one or more processor units located in one or more hardware devices in one or more computer systems.

In the illustrative example, the process can be implemented in information manager 130 in FIG. 1 or information manager 214 in computer system 212 in FIG. 2. In this example, information manager 214 information manager 130 can be configured to receive any user input.

The process begins by receiving input information with a data type (step 1200). In this illustrative example, the input information can be organized to have fields. The fields can have different field types, such as, first name, last name, address, date of birth, address, and other field types that may be present for the data type.

The process performs standardization on the input information (step 1202). In step 1202, the process performs standardization on the input information in manner that can reduce issues in performing full text searching of the information. This standardization can reduce the impact of typographical errors, equivalent variation of information. The standardization can also remove noise from the text by deleting unwanted characters. In this illustrative example, standardization of formatted text can be deriving a fixed letter case of different part of the fields. With images, the standardization can reduce the content of images to find the dimensions of the image and use dimensions for computation.

The process loads the input information into a text search engine (step 1204). The text search engine can perform full text searching. The process receives user input selecting matching fields (step 1206). In step 1206, the user input selects what fields in input information that can be used for matching records.

The process also receives a user input selecting a number of regions for classifying the matching outcomes and the boundaries of the regions (step 1208). In step 1208, the user input also includes values or information defining the boundaries for these regions. When a comparison of a pair of records falls into a particular region based on the boundaries, the result of this comparison can be referred to as an outcome.

The process identifies an importance map (step 1210). In step 1210, the identified importance map can be an existing importance map. For example, existing importance map can be a default importance map or an importance map used by another matching process. This identification can be made by a user input selecting an importance map or a default importance map can be used without needing user input. When the importance map is a default importance map, this map can be an importance map that includes linear function for predefined importance value for every dimension of the matching fields. In this example, the sum of maximum and minimum of importance values does not exceed the maximum or minimum of boundaries defined in step 1208.

The process generates matching pairs of records (step 1212). In step 1212, the generation of the matching pairs of records includes selecting a record. The selected record is used to search the input information loaded into the text searching for matching records that match the selected record. This search can be performed for any number of selected records.

In step 1212, the text search engine can search for a record that have similar value in any of the fields of those records. In this example, the search can be a fuzzy search such that exact matches are not the only results returned. In this illustrative example, the selected record and the record returned by the text search engine form a matching pair of records.

The process generates training pairs (step 1214). In step 1214, the process generates the training pairs using the matching pairs. In this illustrative example, the records in the matching pair of records can be compared to each other to determine dimension values for dimensions for the matching fields. For example, a comparison of distance or similarity of dimensions for the matching fields in the matching pair of records can be performed.

The dimension values for the different dimensions matching fields can be used to determine the similarity between the two records in the matching pair of records. In this illustrative example, a training pair comprises dimension values for dimensions from a comparison of matching fields between the matching pair of records corresponding to the training pair.

In this illustrative example, the training pairs can be in form of a flat file containing values for the dimensions for the different matching fields. For example, a sequence of 5 values can be dimension values for the one field and the next 7 values can be dimension values for another field. In this illustrative example, the training pairs can include different number of dimensions for different matching fields. For example, the importance map can have importance value for dimension 1 to dimension 5 for matching field in first row but dimension 6-10 for the matching field in the second row.

The process refines the training pairs (step 1216). In step 1216, the process determines whether the training pairs are erroneously matched or actual matches with each other and can update the training pairs based on these determinations. A training pair can be erroneous if the match is a false positive or the lack of a match is a false negative. The training pairs can be updated with the determinations to form refined training pairs.

For example, if a training pair is determined to be erroneously matched, the training pairs can be updated with an indication of no match. On the other hand, if the similarity of a training pair suggests a no match but the training pair is actually a match, the training pair can be updated with an indication of a match. In this illustrative example, the indication can be updated to the training pairs by any suitable method. For example, the update can be adding a label to the training pairs or manually overwriting the similarity of training pairs.

The process trains the machine learning model with the training data set to generate Shapley values (step 1218). In step 1218, the Shapley values can be used to determine importance values for each dimension for each matching field. The process generates a new importance map using the Shapley values (step 1220). In step 1220, the new importance map can be determined using any suitable statistical method, for example, averaging, regression, approximation, or other suitable statistical methods.

The process compares the new importance map with existing importance map (step 1222). In step 1222, the two importance maps can be compared to identify the similarity between the two importance maps.

The process determines whether the new importance map is acceptable (step 1224). In step 1224, the process can determine if an adjustment to the importance map is needed. For example, a matching field can be excluded from the importance map if that a matching field does not contribute to the similarity in matching records. If the process determines that the new importance map is not satisfactory, the process returns to step 1206.

If the new importance map is acceptable, the process updates the existing importance map using the new importance map to form an updated importance map (step 1226). The process terminates thereafter.

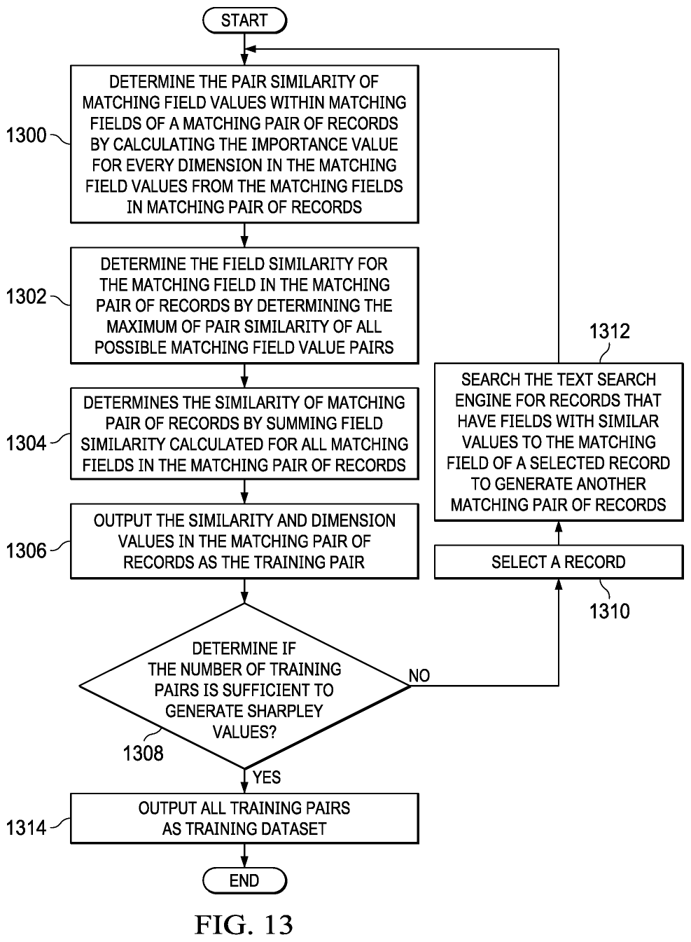

Turning next to FIG. 13, a flowchart of a process for generating training pairs is depicted in accordance with an illustrative embodiment. The process in FIG. 13 can be implemented in hardware, software, or both. When implemented in software, the process can take the form of program code that is run by one or more processor units located in one or more hardware devices in one or more computer systems. This process can be implemented in information manager 130 in FIG. 1 or information manager 214 in computer system 212 in FIG. 2. The process in this step is an example of one implementation of step 1214 in FIG. 12A.

The process begins by determining pair similarity of the matching field values within matching fields in a matching pair of records by calculating the importance value for every dimension of the matching field values from matching field in the matching pair of records (step 1300). In step 1300, the determination of pair similarity can be performed using the following equation:

Ps(v1,v2)=Σₚ₌₀^{q}imp(FIELDk,fₚ,fvₚ) (1)

where v1 and v2 are values from two corresponding matching fields of matching pair of records, imp( ) function is used to determine the importance value of dimension p of given matching field k, and q is the number of dimensions selected. As depicted, imp( ) is the importance value of a given field (FIELDₖ) for a dimension (fₚ) having a dimension value (fvₚ). In this illustrative example, the importance values of the dimensions can be obtained from the existing importance map.

For example, a matching pair of records r1 and r2 can be record r1:{f1:[v1, v2], f2:[v3]} and record r2:{f1:[v4,v5], f2:[v6,v7]}. In this example v1, v2, v3, v4, v5, v6, and v7 are values. These values can be words. The importance values of dimensions for field f1 from the existing importance map can be {EX: {0:0.10, 1:0.08, 2:0.06}, EQ:{0:0.06, 1:0.04, 2:0.03, 3:0.02}, UM: {0:0.00, 1:−0.05, 2:−0.10} }, When comparing values v1 and v4 from record r1 and record r2, the result can be in comparison matrix [EX:1, EQ;0, UM:1]. In this example, 1 exact match, 0 equivalent matches, and 1 unmatch are present when comparing field values of v1 and v4 for field f1. The pair similarity of values v1 and v2 of matching field f1 is computed by: ps(v1 vs v4)=ps([EX:1, EQ:0, UM:1])=imp(f1,EX,1)+imp(f1,EQ,0)+imp(f1,UM,1)=0.08+0.06−0.05=0.09.

The process determines the field similarity for the matching field in the matching pair of records by determining the maximum pair similarity of all possible matching field pairs (step 1302). In step 1302, the pair similarities determined in step 1300 are used to determine the field similarity. the field similarity is computed by identifying the maximum of pair similarity if all possible matching field value pairs. Field similarity for a field can be determined as follows:

fs(FIELDₖ)=max [ps(r1[FIELDₖ][i],r2[FIELDₖ][j])] (2)

where i and j are respective index of field values present in matching field k in record r1 and matching field k in record r2. For example, a matching pair of records r1 and r2 can be as follows: record r1:{f1:[v1, v2], f2:[v3]} and record r2:{f1:[v4,v5], f2:[v6,v7]}. With this matching pair of records r1 and r2, the field similarity of field 1 is fs(f1)=max(ps(v1 vs v4), ps(v1 vs v5), ps(v2 vs v4), ps(v2 vs v5)).

The process then determines the similarity of the matching pair of records by summing the field similarity calculated for all matching fields in the matching pair of records (step 1304). In step 1304, the similarity of matching pair of records can be determined by summing the field similarities determined in step 1302 for all matching fields of the matching pair of records. The similarity of the pair of records r1 and r2 can be determined as follows:

similarity(r1,r2)=Σₖ₌₀ⁿfs(FIELDk) (3)

where r1 is a first record in a pair of records, r2 is a second record in a pair of records, k is an index number for matching fields, n is the number of matching fields between record r1 and r2, FIELDk is a field k in the matching fields.

The process forms a training pair using the dimension values and similarity of the matching pair of records (step 1306). In step 1306, the training pair can also include other information relating to the matching pair of records. For example, indication of matching fields that have been selected can also be included in the training pair of records.

The process determines whether the number of training pairs is sufficient for training machine learning model to generate Shapley values (step 1308). In step 1308, the determination can be based on a user input of user preference or a threshold for the number of training pairs that are sufficient for training a machine learning model to generate Shapley values.

If the number of training pairs is not sufficient to generate the Shapley values, the process selects a record (step 1310). The process searches a text search engine for records that have fields with similar values to the matching field of the selected record to generate another matching pair of records (step 1312). In step 1312, the process can use the text search engine to search for records that have fields with similar values to the matching field of the selected record to generate another matching pair of records. The process then repeats step 1300 through step 1306 to generate another training pair.

If the number of training pairs are sufficient to generate the Shapley values, generate all training pairs as training data set (step 1314). The process terminates thereafter.

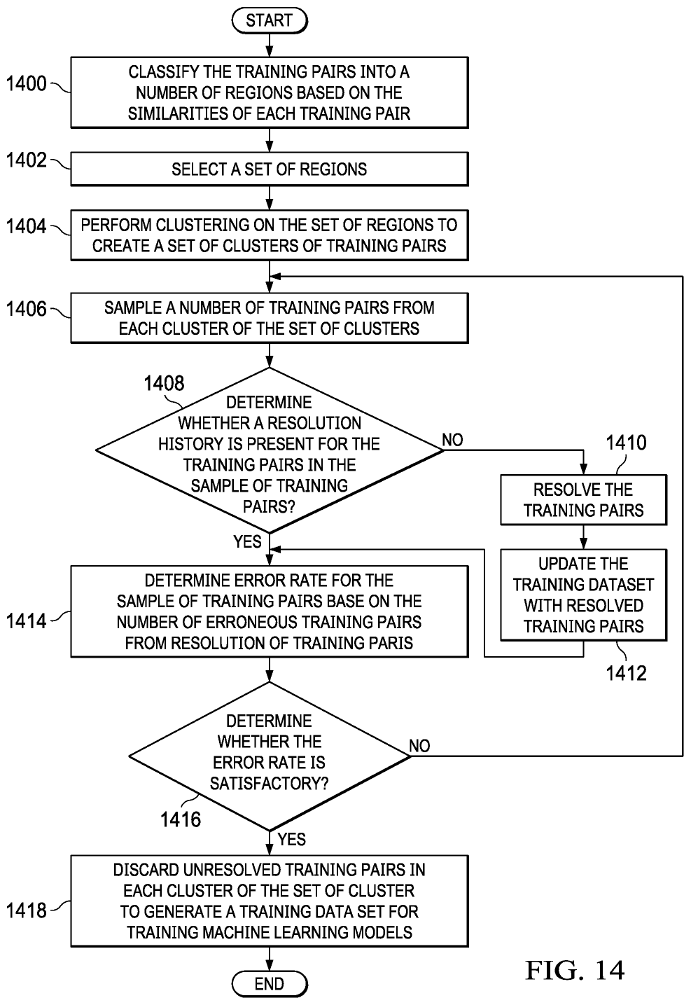

Turning next to FIG. 14, a flowchart of a process for refining training pairs is depicted in accordance with an illustrative embodiment. The process in FIG. 14 can be implemented in hardware, software, or both. When implemented in software, the process can take the form of program code that is run by one or more processor units located in one or more hardware devices in one or more computer systems. This process can be implemented in information manager 214 in matching system 202 in FIG. 2 or information manager 130 in FIG. 1. The process in this step can be used to implement step 1216 in FIG. 12A.

The process begins by classifying the training pairs into a number of regions based on the similarity of each training pair (step 1400). In step 1400, these regions are outcomes based on the similarity determined for two records in a pair of records corresponding to the training pair.

The process selects a set of regions from the number of regions (step 1402). The process performs clustering on the set of regions to create a set of clusters of training pairs (step 1404). In step 1404, the clustering of training pairs can be achieved using any suitable statistical method. A statistical method that can be used includes, for example, a DBSCAN clustering method, a K-Means clustering method, or other suitable statistical methods.

As used herein, a “set of” used with reference to items means one or more items. For example, a set of regions is one or more regions.

The process samples a number training pairs from each cluster of the set of clusters of training pairs to identify sample training pairs for processing (step 1406). The process determines whether a resolution history is present for the training pairs in the samples of training pairs (step 1408). In step 1408, a training pair can have a resolution history if similarity of training pair has been previously determined as erroneous or not erroneous.

For example, the outcomes for training pairs may have been previously determined as a false positive. The outcome is a region determined for a training pair based on the similarity for the training pair. In one case, the similarities for training pairs can indicate matching. The training pairs, however, are in not actually matched. In another case, the similarities for training pairs can indicate false negative. In other words, similarities for training pairs indicate no match while the training pairs are actually matched.

If a resolution history is not present, the process resolves the training pairs in the samples (step 1410). In step 1410, the process can resolve the training pairs by determining whether outcome of similarity is erroneous. The resolution can be performed by receiving user input from a user or through a machine learning model. With this user input, the process in step 1410 can update the training pairs with resolutions from the user input as part of the resolution step.

The process updates the training data set with resolved training pairs (step 1412). The process determines the error rate for the sampled training pairs based on the number of training pairs that have been resolved to be erroneous (step 1414). For example, in a sample of 100 training pairs, if 5 training pairs have been resolved to be false positive and 5 training pairs have been resolved to be false negative, the error rate of the sample training pairs is 10%. The process also proceeds to step 1414 from step 1408 if a resolution history is present for the training pairs in the sample of training pairs.

The process determines whether the error rate for the sample of training pairs is satisfactory (step 1416). In step 1416, the determination of whether error rate is satisfactory can be done by receiving a user input or through comparison with a predefined threshold.

If the error rate for the sample of training pairs is not satisfactory, the process returns to step 1406 to sample more training pairs and subsequently resolve newly collected training pairs to bring error rate to an acceptable level.

If the error rate of the sampled training pairs is acceptable, the process discards the unresolved training pairs in each cluster of the set of clusters to generate a training data set for training the machine learning model (step 1418). The process terminates thereafter.

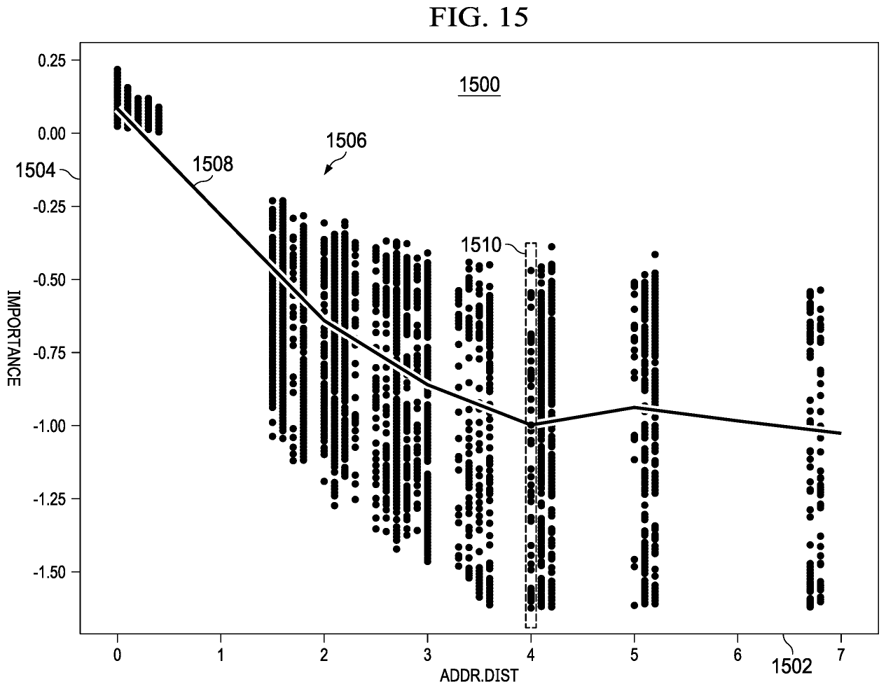

With reference to FIG. 15, a graph of Shapley values and importance values is depicted in accordance with an illustrative embodiment. In this illustrative example, graph 1500 is an example of Shapley values and importance values for a dimension in a field. As depicted, the dimension is distance, and the field that is address. As shown in graph 1500, x-axis 1502 is for a distance for an address field, and y-axis 1504 is an importance for a particular distance.

In this illustrative example, Shapley values are represented by data points 1506 while the importance of values are represented by line 1508. The importance values in line 1508 can be determined using the Shapley values represented by data points 1506. For example, the importance value in line 1508 at a distance 4.0 is −0.97. In this illustrative example, the importance value can be determined based on an average of the Shapley values in section 1510.

This determination can be performed for each distance for which Shapley values are present. These points in graph 1500 for these importance values can then be used to determine line 1508 for all of the importance values that may be present from distance 0 to distance 7. This type of determination can be performed for all of the dimensions all of the matching fields to determine importance values for an importance map based on the Shapley values. This type of determination can be used to generate importance map 224 in FIG. 2 and importance map 400 in FIG. 4. In other illustrative examples, other statistical techniques can be used such median can be used to determine the importance values.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

For example, step 1216 is an optional step in which refining of training pairs occurs. As another example, step 1206 also is an optional step.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

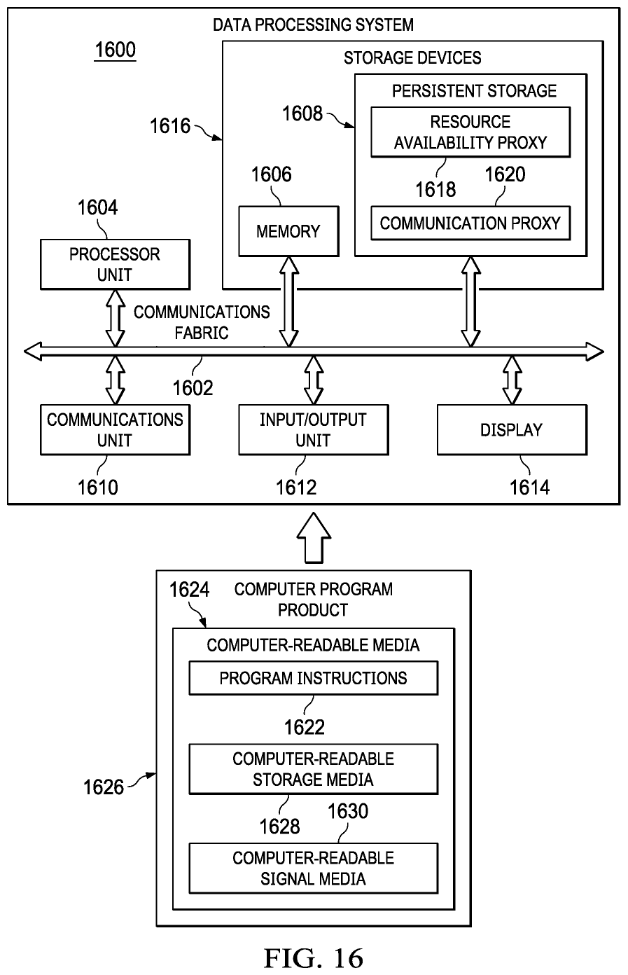

Turning now to FIG. 16, a block diagram of a data processing system is depicted in accordance with an illustrative embodiment. Data processing system 1600 can be used to implement server computer 104, server computer 106, client devices 110, in FIG. 1. Data processing system 1600 can also be used to implement computer system 212 in FIG. 2. In this illustrative example, data processing system 1600 includes communications framework 1602, which provides communications between processor unit 1604, memory 1606, persistent storage 1608, communications unit 1610, input/output (I/O) unit 1612, and display 1614. In this example, communications framework 1602 takes the form of a bus system.

Processor unit 1604 serves to execute instructions for software that can be loaded into memory 1606. Processor unit 1604 includes one or more processors. For example, processor unit 1604 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1604 can may be implemented using one or more heterogeneous processor systems in which a main processor is present with secondary processors on a single chip. As another illustrative example, processor unit 1604 can be a symmetric multi-processor system containing multiple processors of the same type on a single chip.

Memory 1606 and persistent storage 1608 are examples of storage devices 1616. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1616 may also be referred to as computer-readable storage devices in these illustrative examples. Memory 1606, in these examples, can be, for example, a random-access memory or any other suitable volatile or non-volatile storage device. Persistent storage 1608 may take various forms, depending on the particular implementation.

For example, persistent storage 1608 may contain one or more components or devices. For example, persistent storage 1608 can be a hard drive, a solid-state drive (SSD), a flash memory, a rewritable optical disk, a rewritable magnetic tape, or some combination of the above. The media used by persistent storage 1608 also can be removable. For example, a removable hard drive can be used for persistent storage 1608.

Communications unit 1610, in these illustrative examples, provides for communications with other data processing systems or devices. In these illustrative examples, communications unit 1610 is a network interface card.

Input/output unit 1612 allows for input and output of data with other devices that can be connected to data processing system 1600. For example, input/output unit 1612 may provide a connection for user input through at least one of a keyboard, a mouse, or some other suitable input device. Further, input/output unit 1612 may send output to a printer. Display 1614 provides a mechanism to display information to a user.

Instructions for at least one of the operating system, applications, or programs can be located in storage devices 1616, which are in communication with processor unit 1604 through communications framework 1602. The processes of the different embodiments can be performed by processor unit 1604 using computer-implemented instructions, which may be located in a memory, such as memory 1606.

These instructions are referred to as program instructions, computer usable program instructions, or computer-readable program instructions that can be read and executed by a processor in processor unit 1604. The program instructions in the different embodiments can be embodied on different physical or computer-readable storage media, such as memory 1606 or persistent storage 1608.

Program instructions 1618 is located in a functional form on computer-readable media 1620 that is selectively removable and can be loaded onto or transferred to data processing system 1600 for execution by processor unit 1604. Program instructions 1618 and computer-readable media 1620 form computer program product 1622 in these illustrative examples. In the illustrative example, computer-readable media 1620 is computer-readable storage media 1624.

Computer-readable storage media 1624 is a physical or tangible storage device used to store program instructions 1618 rather than a medium that propagates or transmits program instructions 1618. Computer readable storage media 1624, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1618 can be transferred to data processing system 1600 using a computer-readable signal media. The computer-readable signal media are signals and can be, for example, a propagated data signal containing program instructions 1618. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1620” can be singular or plural. For example, program instructions 1618 can be located in computer-readable media 1620 in the form of a single storage device or system. In another example, program instructions 1618 can be located in computer-readable media 1620 that is distributed in multiple data processing systems. In other words, some instructions in program instructions 1618 can be located in one data processing system while other instructions in program instructions 1618 can be located in one data processing system. For example, a portion of program instructions 1618 can be located in computer-readable media 1620 in a server computer while another portion of program instructions 1618 can be located in computer-readable media 1620 located in a set of client computers.

The different components illustrated for data processing system 1600 are not meant to provide architectural limitations to the manner in which different embodiments can be implemented. In some illustrative examples, one or more of the components may be incorporated in or otherwise form a portion of, another component. For example, memory 1606, or portions thereof, may be incorporated in processor unit 1604 in some illustrative examples. The different illustrative embodiments can be implemented in a data processing system including components in addition to or in place of those illustrated for data processing system 1600. Other components shown in FIG. 16 can be varied from the illustrative examples shown. The different embodiments can be implemented using any hardware device or system capable of running program instructions 1618.

Thus, illustrative embodiments of the present invention provide a computer implemented method, computer system, and computer program product for processing information. In one illustrative example, a method processes information. Training pairs are generated by a computer system using matching fields in matching pairs of records for a data type, wherein matches are present between the matching fields in the matching pairs of records. Similarities between the training pairs are determined by the computer system using an importance map with importance values for the matching fields. Shapley values are determined by the computer system using the training pairs and the similarities between the training pairs. The importance map is adjusted by the computer system using the Shapley values.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, To the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A method for processing information, the method comprising:
generating, by a computer system, training pairs using matching fields in matching pairs of records for a data type, wherein matches are present between the matching fields in the matching pairs of records;
determining, by the computer system, similarities between the training pairs using an importance map with importance values for the matching fields;
determining, by the computer system, Shapley values using the training pairs and the similarities between the training pairs; and
adjusting, by the computer system, the importance map using the Shapley values.

2. The method of claim 1 further comprising:
repeating, by the computer system, generating the training pairs, determining the similarities, determining the Shapley values, and adjusting the importance map until the similarities determined for the training pairs using the importance map are satisfactory for the data type.

3. The method of claim 1 further comprising:
comparing, by the computer system, the importance map adjusted with the Shapley values to the importance map without adjustments to form a comparison.

4. The method of claim 1 further comprising:
selecting, by the computer system, regions for classifying the similarities for the training pairs, wherein the similarities for the training pairs is used to identify the regions for the training pairs.

5. The method of claim 1, wherein, generating, by the computer system, the training pairs using the matching fields in the matching pairs of records for the data type, wherein matches are present between the matching fields in the matching pairs of records comprises:
identifying, by the computer system, the matching pairs of records as matches between a selected record and other records by matching selected values for the matching fields in the selected record with other values for the matching fields in the other records;
determining dimension values for dimensions in the matching fields for the matching pairs of records;
determining, by the computer system, the similarities between the matching pairs of records using the dimension values and the importance map; and
associating, by the computer system, the training pairs with the similarities between the matching pairs of records, wherein the dimension values and the similarities are used for training a machine learning model to generate the Shapley values.

6. The method of claim 5, wherein identifying, by the computer system, the matching pairs of records as matches between the selected record and the other records by matching the selected values for the matching fields in the selected record with the other values for the matching fields in the other records comprises:
selecting, by the computer system, the selected record; and
performing, by the computer system, a text search for the information present in the matching fields of the selected record using a text search engine, wherein the text search engine returns the other records having matches in the matching fields to the selected record.

7. The method of claim 1, wherein determining, by the computer system, the Shapley values using the training pairs and the similarities between the training pairs comprises:
training a machine learning model using the training pairs and the similarities between the training pairs, wherein the machine learning model trained using the training pairs generates the Shapley values in response to training the machine learning model using the training pairs and wherein the Shapley values comprises values for dimensions in the matching fields in the training pairs.

8. The method of claim 1, wherein adjusting, by the computer system, the importance map using the Shapley values comprises:
adjusting, by the computer system, the matching fields used for matching, a dimension determined for the matching fields, or a similarity value in the similarity values.

9. The method of claim 1, wherein determining, by the computer system, the similarities between the training pairs using the importance map with the importance values for the matching fields comprises:
determining, by the computer system, the similarities between the training pairs using the importance map with the importance values for dimensions determined for the matching fields.

10. The method of claim 1 further comprising:
refining, by the computer system, the training pairs by:
clustering the training pairs in a region for the similarities into a set of clusters based on the similarities of the training pairs in the region;
responsive to receiving a user input resolving a sample of training pairs in each cluster in the region; updating the training pairs with resolutions from the user input; and
discarding, in each cluster, unresolved training pairs in the region.

11. The method of claim 1 further comprising:
performing, by the computer system, matching of the information of the data type with a matching process using the importance map adjusted using the Shapley values.

12. A matching system comprising:
a computer system, wherein the computer system executes instructions to:
generate training pairs using matching fields in matching pairs of records for a data type, wherein matches are present between the matching fields in the matching pairs of records;
determine similarities between the training pairs using an importance map with importance values for the matching fields;
determine Shapley values using the training pairs and the similarities between the training pairs; and
adjust the importance map using the Shapley values.

13. The matching system of claim 12 further comprising:
repeating, by the computer system, generating the training pairs, determining the similarities, determining the Shapley values, and adjusting the importance map until the similarities determined for the training pairs using the importance map are satisfactory for the data type.

14. The matching system of claim 12 further comprising:
comparing, by the computer system, the importance map adjusted with the Shapley values to the importance map without adjustments to form a comparison.

15. The matching system of claim 12 further comprising:
selecting, by the computer system, regions for classifying the similarities for the training pairs, wherein the similarities for the training pairs is used to identify the regions for the training pairs.

16. The matching system of claim 12, wherein generating, by the computer system, the training pairs using the matching fields in the matching pairs of records for the data type, wherein matches are present between the matching fields in the matching pairs of records comprises:
identifying, by the computer system, the matching pairs of records as matches between a selected record and other records by matching selected values for the matching fields in the selected record with other values for the matching fields in the other records;
determining dimension values in the matching fields for the matching pairs of records;
determining, by the computer system, the similarities between the matching pairs of records using the dimension values and the importance map; and
associating, by the computer system, the training pairs with the similarities between the matching pairs of records, wherein the dimension values and the similarities are used for training a machine learning model to generate the Shapley values.

17. The matching system of claim 16, wherein identifying, by the computer system, the matching pairs as matches between the selected record and the other records by matching the selected values for the matching fields in the selected record with the other values for the matching fields in the other records comprises:
selecting, by the computer system, the selected record; and
performing, by the computer system, a text search for information present in the matching fields of the selected record using a text search engine, wherein the text search engine returns the other records having matches in the matching fields to the selected record.

18. The matching system of claim 12, wherein determining, by the computer system, the Shapley values using the training pairs and the similarities between the training pairs comprises:
training a machine learning model using the training pairs and the similarities between the training pairs, wherein the machine learning model trained using the training pairs generates the Shapley values in response to training the machine learning model using the training pairs and wherein the Shapley values comprises values for dimensions in the matching fields in the training pairs.

19. A computer program product for comparing information, the computer program product comprising a computer readable storage medium having program instructions embodied therewith, the program instructions executable by a computer system to cause the computer system to perform a method comprising:
generating, by the computer system, training pairs using matching fields in matching pairs of records for a data type, wherein matches are present between the matching fields in the matching pairs of records;
determining, by the computer system, similarities between the training pairs using an importance map with importance values for the matching fields;
determining, by the computer system, Shapley values using the training pairs and the similarities between the training pairs; and
adjusting, by the computer system, the importance map using the Shapley values.

20. A computer program product of claim 19, wherein the program instructions are executable by the computer system to cause the computer system to perform:
repeating, by the computer system, generating the training pairs, determining the similarities, determining the Shapley values, and adjusting the importance map until the similarities determined for the training pairs using the importance map are satisfactory for the data type.
